(19) United States
(12) Patent Application Publication
(10) Pub. No.: US 2009/0282348 A1
(43) Pub. Date: Nov. 12, 2009

(54) METHOD AND SYSTEM FOR ENHANCED MANAGEMENT OF MEETING CANCELLATIONS

(75) Inventors: Gerald Francis McBrearty, Austin, TX (US); Shawn Patrick Mullen, Buda, TX (US); Jessica Carol Murillo, Round Rock, TX (US); Johnny Meng-Han Shieh, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 12/118,151

(22) Filed: May 9, 2008

(51) Int. Cl. G06F 3/048

(52) U.S. Cl. 715/753

(57) ABSTRACT

The illustrative embodiments provide a computer implemented method and computer program product for managing a meeting cancellation. A selection of a meeting entry on a calendar for cancellation is received and a cancellation notification is sent to all invitees of the meeting. The meeting entry is marked as cancelled on each calendar of each invitee. Upon receiving a confirmation of the cancellation notification from an invitee, a percentage of cancellation confirmations received is calculated and the meeting entry is marked with the percentage of cancellation confirmations received.

### BACKGROUND OF THE INVENTION

1. Field of the Invention

The present invention relates generally to an improved data processing system and in particular to electronic calendars. More specifically, the present invention is directed to a computer implemented method, apparatus, and computer usable program code for managing electronic calendars.

2. Description of the Related Art

There is an increased dependence on electronic communication in day to day business and social interactions. Meetings can be scheduled, participants notified, and dates and times for meetings accepted or modified with little or no personal interaction. When a meeting with multiple participants is cancelled, there can be a lag time in each participant receiving the cancellation notice, or miscommunication if the person canceling the meeting simply removes the entry from his or her personal calendar without informing each and every participant. Time can be spent inefficiently as participants seek to confirm whether or not a meeting is cancelled by calling the meeting coordinator, or other participants, to check on the meeting status.

### BRIEF SUMMARY OF THE INVENTION

According to one embodiment of the present invention, the illustrative embodiments provide a computer implemented method and computer program product for managing a meeting cancellation. A selection of a meeting entry on a calendar for cancellation is received and a cancellation notification is sent to all invitees of the meeting. The meeting entry is marked as cancelled on each calendar of each invitee. Upon receiving a confirmation of the cancellation notification from an invitee, a percentage of cancellation confirmations received is calculated and the meeting entry is marked with the percentage of cancellation confirmations received.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which illustrative embodiments may be implemented;

FIG. 2 is a block diagram of a data processing system in which illustrative embodiments may be implemented;

FIG. 3 is a block diagram of a meeting manager utilizing an email and calendar application in accordance with an illustrative embodiment; and

FIG. 4 is a flowchart illustrating a process for managing a meeting with owner specific confirmation tracking in accordance with an illustrative embodiment.

### DETAILED DESCRIPTION OF THE INVENTION

As will be appreciated by one skilled in the art, the present invention may be embodied as a system, method, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example, but not limited to, an electronic, magnetic, optical, electromagnetic, infrared, semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media, such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including, but not limited to wireless, wireline, optical fiber cable, RF, etc.

Computer program code for carrying out operations of the present invention may be written in any combination of one or more programming languages, including an object oriented programming language, such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

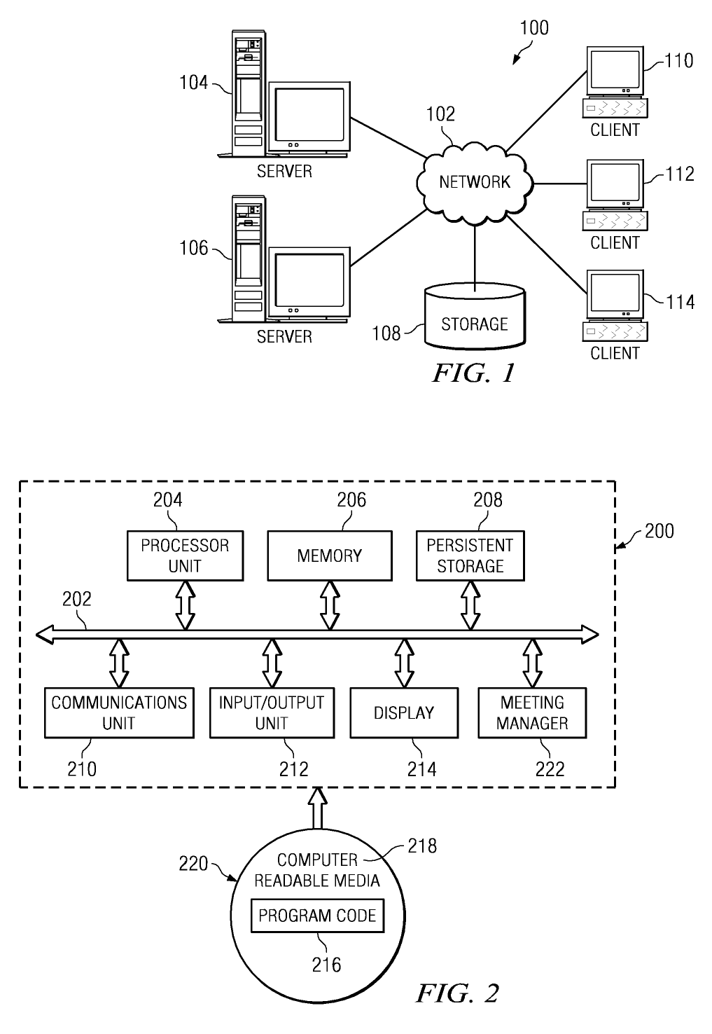

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications, such as electronic mail applications and calendar applications, to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational, and other computer systems that route data and messages. Of course, network data processing system 100 also may be implemented as a number of different types of networks, such as, for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which illustrative embodiments may be implemented. Data processing system 200 is an example of a computer, such as server 104 or client 110 in FIG. 1, in which computer usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, display 214, and meeting manager 222.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user. Meeting manager 222 is a calendar application that interacts with electronic mail applications to send notifications and track confirmation responses.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer usable program code, or computer readable program code that may be read and executed by a processor in processor unit 204. The program code in the different embodiments may be embodied on different physical or tangible computer readable media, such as memory 206 or persistent storage 208.

Program code 216 is located in a functional form on computer readable media 218 that is selectively removable and may be loaded onto or transferred to data processing system 200 for execution by processor unit 204. Program code 216 and computer readable media 218 form computer program product 220 in these examples. In one example, computer readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable media 218 also may take the form of a persistent storage, such as a hard drive, a thumb drive, or a flash memory that is connected to data processing system 200. The tangible form of computer readable media 218 is also referred to as computer recordable storage media. In some instances, computer recordable media 218 may not be removable.

Alternatively, program code 216 may be transferred to data processing system 200 from computer readable media 218 through a communications link to communications unit 210 and/or through a connection to input/output unit 212. The communications link and/or the connection may be physical or wireless in the illustrative examples. The computer readable media also may take the form of non-tangible media, such as communications links or wireless transmissions containing the program code.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown.

As one example, a storage device in data processing system 200 is any hardware apparatus that may store data. Memory 206, persistent storage 208, and computer readable media 218 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache, such as found in an interface and memory controller hub that may be present in communications fabric 202.

The illustrative embodiments recognize a need for an electronic meeting manager that processes meeting cancellations, notifies all participants simultaneously through electronic mail, and tracks confirmations acknowledging each participants receipt of the cancellation notice before completely removing a meeting from a calendar.

The embodiments recognize that although current methods allow for a cancelled meeting to be removed from multiple calendars by the meeting creator, removing a calendar entry does not effectively notify a meeting participant that the meeting has been cancelled. When a participant notices that a calendar entry has disappeared, he or she is often compelled to contact other participants or the meeting creator to confirm that the meeting has actually been cancelled and the deletion of an entry is not a mistake or a computer error. Furthermore, a participant may not notice that a calendar entry has been removed, and may unnecessarily set aside time or appear for a cancelled meeting.

Therefore, the illustrative embodiments provide a computer implemented method and computer program product for managing a meeting cancellation. A selection of a meeting entry on a calendar for cancellation is received and a cancellation notification is sent to all invitees of the meeting. The meeting entry is marked as cancelled on each calendar of each invitee. Upon receiving a confirmation of the cancellation notification from an invitee, a percentage of cancellation confirmations received is calculated and the meeting entry is marked with the percentage of cancellation confirmations received.

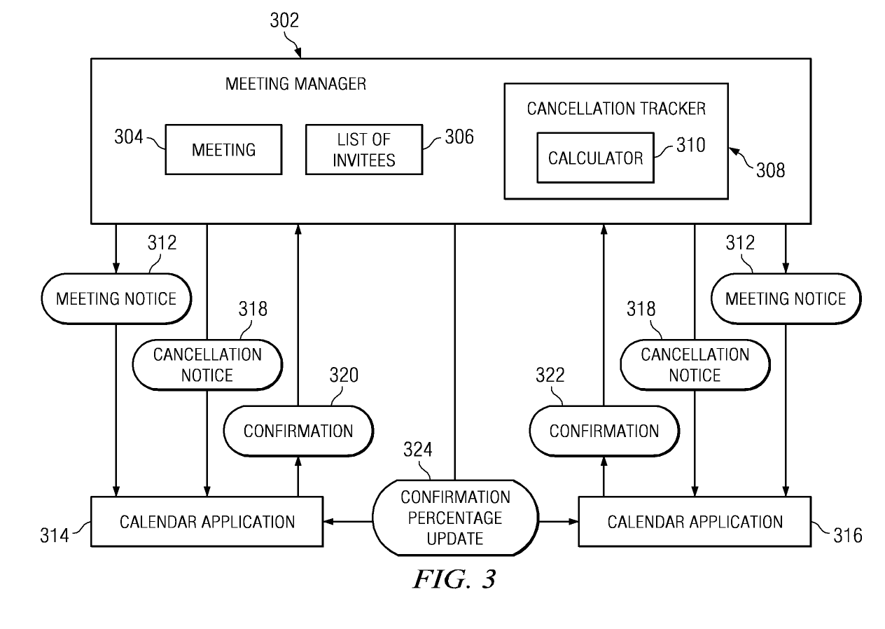

With reference now to FIG. 3, a block diagram of a meeting manager utilizing an email and calendar application is shown in accordance with an illustrative embodiment. Meeting manager 302 is an example of a calendar application, such as meeting manager 222 in FIG. 2.

Meeting manager 302 manages the notifications and cancellations of meetings. Meeting manager 302 includes meeting 304, which is a current meeting set on the calendar, list of invitees 306, which is a list of all participants to meeting 304, and cancellation tracker 308. Cancellation tracker 308 includes calculator 310. Cancellation tracker 308 is a tracking feature that calculates the percentage of meeting participants that confirm cancellation of a meeting, and removes meeting 304 from one or more calendars when confirmation is complete. In one embodiment, cancellation tracker 308 may be customized to change the display features of meeting 304 to indicate the percentage of cancellation confirmations. In another embodiment, cancellation tracker 308 may be customized to remove meeting 304 from each participant's calendar as the confirmation from that participant is received. In yet another embodiment, cancellation tracker 308 may be customized to remove meeting 304 only after all confirmations from each meeting participant have been received.

When meeting 304 and list of invitees 306 is created by a meeting chair, meeting manager 302 sends meeting notice 312 to calendar application 314 and calendar application 316. Calendar application 314 and calendar application 316 are calendar applications of individuals on list of invitees 306. When meeting 304 is subsequently cancelled by the meeting chair, cancellation notice 318 is sent to all participants in the list of invitees 306. In the illustrative embodiment, cancellation notice 318 is sent to calendar application 314 and calendar application 316. As each participant acknowledges receipt of cancellation notice 318, a cancellation confirmation is sent to meeting manager 302 that uniquely identifies the participant acknowledging receipt of cancellation notice 318. In the illustrative embodiment, calendar application 314 sends cancellation confirmation 320, and calendar application 316 sends cancellation confirmation 322. The cancellation confirmations are recorded by cancellation tracker 308, and cancellation tracker 308 then uses calculator 310 to calculate the percentage, ratio, or number of cancellation confirmations received. Meeting manager 302 then sends confirmation percentage update 324 to calendar application 314 and calendar application 316. In one embodiment, the percentage, ratio, or number is displayed to one or more participants in the set of participants. Confirmation percentage update 324 contains the percentage, ratio, or number calculated by cancellation tracker 308. In one embodiment, the percentage, ratio, or number may also be displayed to the chair only, to all participants in the set, or to one or more participants in the set that select to receive the percentage, ratio or number in order to monitor the meeting until all participants have confirmed cancellation and the meeting can be removed permanently from all calendars.

As each cancellation confirmation is received from each participant, a meeting entry on a calendar is modified to reflect the changing status of cancellation confirmations received. In one embodiment, the calendar entry is faded out or displayed with lower resolution as each cancellation confirmation is received. When the last cancellation confirmation is received the calendar entry fades completely out so that the entry can no longer be seen.

In another embodiment, the calendar entry is displayed in a different font color, font size, or font type as each cancellation confirmation is received. For example, the calendar entry appears black when it is first cancelled, dark gray as cancellation confirmations are received, then light gray as more cancellation confirmations are received, then removed completely once all cancellation confirmations are received. In another example, the calendar entry is displayed in a large font size (12), then font size (11), then font size (10), then font size (9), and so on until it is removed completely once all cancellation confirmations are received.

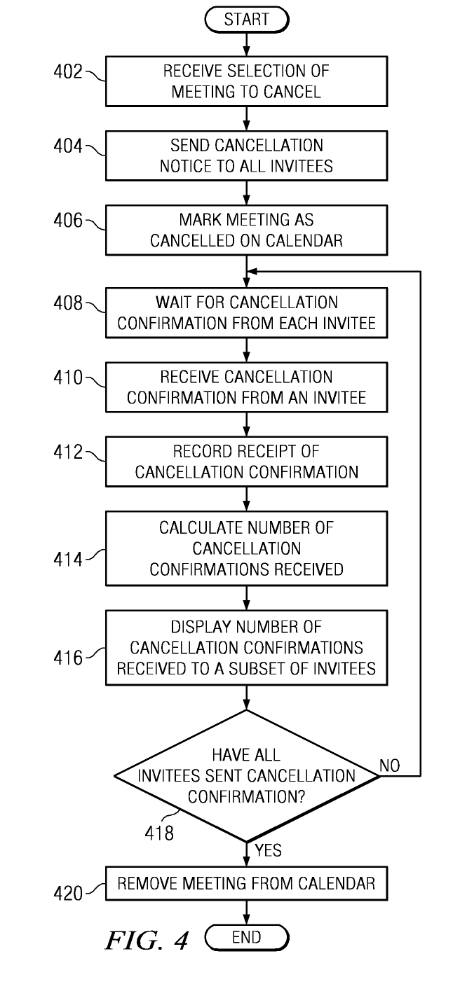

With reference now to FIG. 4, a flowchart illustrating a process for managing a meeting with owner specific confirmation tracking is shown in accordance with an illustrative embodiment. The process in FIG. 4 is implemented by software for managing cancellation of meetings, such as meeting manger 302 in FIG. 3.

The process begins by receiving selection of a meeting to cancel (step 402). The process sends a cancellation notice to all invitees (step 404) and marks the meeting as cancelled on the calendar (step 406). Next, the process waits for cancellation confirmation from each invitee (step 408). The process receives cancellation confirmation from an invitee (step 410) and records receipt of the cancellation confirmation (step 412). Next, the process calculates the number of cancellation confirmations received (step 414). The number may be expressed in a percentage, ratio, and/or a number of participants in the total number of participants confirming cancellation. The process displays the number of cancellation confirmations received to a subset of invitees (step 416). A subset of invitees may be the meeting chair's calendar, all participants' calendars, or only some of the participants that have selected to show the confirmations. Then, the process determines whether all invitees have sent cancellation confirmations (step 418). If confirmations have not been received, the process returns to step 408 to wait on remaining cancellation confirmations. If all invitees have sent cancellation confirmations, the process removes the meeting from the calendar (step 420), with the process terminating thereafter.

Thus, the illustrative embodiments provide a computer implemented method and computer program product for managing a meeting cancellation. A selection of a meeting entry on a calendar for cancellation is received and a cancellation notification is sent to all invitees of the meeting. The meeting entry is marked as cancelled on each calendar of each invitee. Upon receiving a confirmation of the cancellation notification from an invitee, a percentage of cancellation confirmations received is calculated and the meeting entry is marked with the percentage of cancellation confirmations received.

The illustrative embodiments provide the means for an electronic meeting manager to keep track of a cancelled meeting, the participants who have acknowledged receipt of a cancelled meeting notice, and those participants who have not yet noticed or responded to the cancelled meeting notice

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The invention can take the form of an entirely hardware embodiment, an entirely software embodiment or an embodiment containing both hardware and software elements. In a preferred embodiment, the invention is implemented in software, which includes, but is not limited to, firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for managing a meeting cancellation, the computer implemented method comprising:
receiving, by a meeting manager, a selection to cancel a meeting associated with a meeting entry on an electronic calendar by a user, wherein the user is a participant in a set of participants scheduled to attend the meeting,
sending a cancellation notification to each participant in the set of participants;
responsive to receiving a confirmation of the cancellation notification from a participant in the set of participants, calculating a percentage of cancellation confirmations received by the meeting manager;
sending the percentage of cancellation confirmations to a subset of participants in the set of participants, wherein the meeting entry is modified in the calendar associated with each participant in the subset of participants to indicate the percentage, wherein the subset of participants comprises participants that have requested notification of the percentage of cancellation confirmation;
responsive to receiving a confirmation of cancellation from a next participant in the set of participants, calculating an updated percentage of cancellation confirmation by the meeting manager and sending the updated percentage to the subset of participants, wherein the meeting manager iteratively receives cancellation confirmations from participants in the set of participants, calculates an updated percentage, and sends the updated percentage to the subset of participants until a cancellation confirmation is received from all participants in the set of participants; and
responsive to receiving the cancellation confirmation from all participants in the set of participants, removing the meeting entry from the calendar of the user.

2. The method according to claim 1, further comprising:
responsive to receiving the confirmation of the cancellation notification from a given participant in the set of participants, removing the meeting entry from the calendar of the given participant.

3. The method according to claim 1, wherein the percentage of cancellation confirmations received by the meeting manager is a ratio.

4. The method according to claim 1, wherein the meeting chair is in the subset of participants in the set of participants, and wherein the percentage of cancellation confirmations is automatically displayed in the meeting entry on the calendar of the meeting chair.

5. The method according to claim 1, wherein the meeting manager is a first meeting manager, wherein the user is a first participant in the set of participants, and further comprising:
receiving by a second meeting manager associated with a second participant in the set of participants, the cancellation notification;
sending a second cancellation confirmation to the first meeting manager;
modifying a meeting entry in the calendar of the second participant to indicate the meeting is cancelled; and
responsive to receiving a percentage from the first meeting manager, displaying the percentage in the meeting entry in the calendar of the second participant;
responsive to receiving an updated percentage from the first meeting manager, displaying the updated percentage in the meeting entry in the calendar of the second participant, wherein the first meeting manager iteratively sends the updated percentage to the second meeting manager until a cancellation confirmation is received from all participants in the set of participants; and
responsive to receiving the cancellation confirmation from all participants in the set of participants, removing the meeting entry from the calendar of the second participant.

6. The method of claim 1, further comprising:
receiving, by a second meeting manager, a cancellation confirmation from at least one participant in the set of participants;
calculating the percentage of cancellation confirmations received by the second meeting manager; and
sending the percentage of cancellation confirmations received by the second meeting manager to the subset of participants in the set of participants, wherein the meeting entry is modified in the calendar associated with each participant in the subset of participants to indicate the percentage, wherein the subset of participants comprises participants that have requested notification of the percentage of cancellation confirmation;

7. The method of claim 1 further comprising:
modifying a display of the meeting entry to indicate the percentage of cancellation confirmations, wherein the modification comprises at least one of altering a font size, a font color, and a resolution of the meeting entry.

8. A computer program product for managing a meeting cancellation, the computer program product comprising:
computer usable program code for receiving, by a meeting manager, a selection to cancel a meeting associated with a meeting entry on an electronic calendar by a user, wherein the user is a participant in a set of participants scheduled to attend the meeting,
computer usable program code for sending a cancellation notification to each participant in the set of participants;
computer usable program code for, responsive to receiving a confirmation of the cancellation notification from a participant in the set of participants, calculating a percentage of cancellation confirmations received by the meeting manager;
computer usable program code for sending the percentage of cancellation confirmations to a subset of participants in the set of participants, wherein the meeting entry is modified in the calendar associated with each participant in the subset of participants to indicate the percentage, wherein the subset of participants comprises participants that have requested notification of the percentage of cancellation confirmation;
computer usable program code for, responsive to receiving a confirmation of cancellation from a next participant in the set of participants, calculating an updated percentage of cancellation confirmation by the meeting manager and sending the updated percentage to the subset of participants, wherein the meeting manager iteratively receives cancellation confirmations from participants in the set of participants, calculates an updated percentage, and sends the updated percentage to the subset of participants until a cancellation confirmation is received from all participants in the set of participants; and
computer usable program code for, responsive to receiving the cancellation confirmation from all participants in the set of participants, removing the meeting entry from the calendar of the user.

9. The computer program product of claim 8, further comprising:
computer usable program code for, responsive to receiving the confirmation of the cancellation notification from a given participant in the set of participants, removing the meeting entry from the calendar of the given participant.

10. The computer program product of claim 8, wherein the percentage of cancellation confirmations received by the meeting manager is a ratio.

11. The computer program product of claim 8, wherein the meeting chair is in the subset of participants in the set of participants, and wherein the percentage of cancellation confirmations is automatically displayed in the meeting entry on the calendar of the meeting chair.

12. The computer program product of claim 8, wherein the meeting manager is a first meeting manager, wherein the user is a first participant in the set of participants, and further comprising:
computer usable program code for receiving by a second meeting manager associated with a second participant in the set of participants, the cancellation notification;
computer usable program code for sending a second cancellation confirmation to the first meeting manager;
computer usable program code for modifying a meeting entry in the calendar of the second participant to indicate the meeting is cancelled; and
computer usable program code for, responsive to receiving a percentage from the first meeting manager, displaying the percentage in the meeting entry in the calendar of the second participant;
computer usable program code for, responsive to receiving an updated percentage from the first meeting manager, displaying the updated percentage in the meeting entry in the calendar of the second participant, wherein the first meeting manager iteratively sends the updated percentage to the second meeting manager until a cancellation confirmation is received from all participants in the set of participants; and
computer usable program code for, responsive to receiving the cancellation confirmation from all participants in the set of participants, removing the meeting entry from the calendar of the second participant.

13. The computer program product of claim 8, further comprising:
computer usable program code for receiving, by a second meeting manager, a cancellation confirmation from at least one participant in the set of participants;
computer usable program code for calculating the percentage of cancellation confirmations received by the second meeting manager; and
computer usable program code for sending the percentage of cancellation confirmations received by the second meeting manager to the subset of participants in the set of participants, wherein the meeting entry is modified in the calendar associated with each participant in the subset of participants to indicate the percentage, wherein the subset of participants comprises participants that have requested notification of the percentage of cancellation confirmation;

14. The computer program product of claim 8, further comprising:
computer usable program code for modifying a display of the meeting entry to indicate the percentage of cancellation confirmations, wherein the modification comprises at least one of altering a font size, a font color, and a resolution of the meeting entry.

15. A computer implemented method for managing a meeting cancellation, the computer implemented method comprising:
receiving, by a meeting manager, a selection to cancel a meeting associated with a meeting entry on an electronic calendar by a meeting chair, wherein the meeting chair is a participant in a set of participants scheduled to attend the meeting,
sending a cancellation notification to each participant in the set of participants;
responsive to receiving a confirmation of the cancellation notification from a participant in the set of participants, calculating a percentage of cancellation confirmations received by the meeting manager;
automatically displaying the percentage in the meeting entry on the electronic calendar of the meeting chair, wherein the meeting entry is modified to indicate the percentage, and wherein the modification comprises at least one of altering a font size, a font color, and a resolution of the meeting entry;
sending the percentage of cancellation confirmations to a subset of participants in the set of participants, wherein the meeting entry is modified in the calendar associated with each participant in the subset of participants to indicate the percentage, wherein the modification comprises at least one of altering a font size, a font color, and a resolution of the meeting entry, and wherein the subset of participants comprises participants that have requested notification of the percentage of cancellation confirmation;
responsive to receiving a confirmation of cancellation from a next participant in the set of participants, calculating an updated percentage of cancellation confirmation by the meeting manager and sending the updated percentage to the subset of participants, wherein the meeting manager iteratively receives cancellation confirmations from participants in the set of participants, calculates an updated percentage, modifies the meeting entry to indicate the percentage, and sends the updated percentage to the subset of participants until a cancellation confirmation is received from all participants in the set of participants; and
responsive to receiving the cancellation confirmation from all participants in the set of participants, removing the meeting entry from the calendar of the user.
